(19) United States
(12) Patent Application Publication
(10) Pub. No.: US 2022/0402021 A1
(43) Pub. Date: Dec. 22, 2022

(54) REFRACTORY IMPACT PAD

(71) Applicant: HarbisonWalker International Holdings, Inc, Moon Township, PA (US)

(72) Inventors: James D. Dorricott, Nokomis, FL (US); Lawrence J. Heaslip, Grand Bend (CA)

(73) Assignee: HarbisonWalker International Holdings, Inc., Moon Township, PA (US)

(21) Appl. No.: 17/829,467

(22) Filed: Jun. 1, 2022

Related U.S. Application Data
(60) Provisional application No. 63/213,316, filed on Jun. 22, 2021.

(51) Int. Cl. B22D 41/00

(52) U.S. Cl. CPC B22D 41/003

(57) ABSTRACT

A refractory impact pad includes a bottom wall, a side wall, and a top wall. The bottom wall has a basal surface. The side wall extends from a periphery of the bottom wall. The side wall has an inner surface that at least partially encircles the basal surface of the bottom wall. The inner surface of the side wall has inner surface teeth distributed thereon and protruding inwardly from the inner surface of the side wall. The top wall is joined to the side wall and separated from the bottom wall by the side wall. The top wall extends over the inner surface of the side wall and the inner surface teeth of the side wall. The top wall has a bottom surface facing the bottom wall. The bottom surface of the top wall has bottom surface teeth distributed thereon and protruding toward the bottom wall.

### FIELD OF THE INVENTION

The present invention relates generally to devices for controlling fluid flow behavior and dissipating turbulence in a vessel receiving a liquid metal stream and, more particularly, to a refractory impact pad designed to receive a stream of liquid metal incoming to a liquid metal bath contained in the vessel in which the refractory impact pad is being used.

### BACKGROUND OF THE INVENTION

It is well known that flow developed within a liquid metal bath in a vessel receiving an incoming liquid metal stream is typically turbulent in nature. Flow-controlling devices have been conventionally utilized in such vessels to control such flow. Many of these devices include a basal surface that is facing upward with walls extending upward at a periphery of the base. The walls have inner surfaces that overhang a periphery of the basal surface. The overhanging surfaces of the walls can be alternately referred to as an undercut portion, an annular portion that extends inwardly and upwardly, an interior face that is semi-circular about an axis substantially parallel to an impact surface around the entire extent thereof, or channel shaped.

With respect to the fluid flow behavior imparted by flow-controlling devices, the upwardly-facing basal surface of the flow-controlling devices is impacted by a downwardly-directed incoming stream, causing some or all of the stream to be deflected as a flow within the devices toward the walls of the devices. In addition, the overhanging surface of the walls redirects the flow such that a U-turn is made within the devices. The U-turn of the flow can also be referred to as the overhanging surface functioning for reversal of the fluid flow direction generated by the incoming stream, redirection of the pouring stream back into itself, and flow of the molten steel contacting the impact surface outwardly and then turning inwardly.

Unfortunately, the U-turn flow behavior leads to a relatively large-scale turbulent eddy flow within the flow-controlling devices. Turbulent dissipation rate in a flow is inversely proportional to eddy scale. As such, the rate of turbulent energy dissipation is inversely proportional to the eddy size. In general, eddy scale within a refractory impact pad tends to increase as the interior size of the refractory impact pad increases, resulting in decreased turbulence dissipation within the pad and thus a higher degree of turbulence in the flow exiting the pad. A dimension characteristic of the interior size of an impact pad having a wall, or walls, overhanging its impact surface is given by twice the area of the impact surface divided by the sum of the interior lengths of the wall or walls. The turbulent dissipation rate within the pad decreases in proportion to this characteristic dimension.

In many cases, it is difficult to precisely and consistently direct the stream coming into the vessel, as the incoming stream commonly fails to be oriented in a reproducible manner with respect to the liquid metal bath in the vessel. Thus, during liquid metal pouring operations, significant variances occur in a trajectory of stream with respect to the fixed location of any flow-altering/flow-controlling furniture of the vessel. The stream often fails to impact a desired location on the basal surface of an impact pad device. In conventional devices, this failure significantly amplifies turbulence intensity and highly distorts the turbulence distribution.

The occurrence of periods during which the flow rate of the incoming stream is increased is also common. This leads to the increasing of the momentum of the incoming stream. Increased momentum of the incoming stream serves to increase turbulence intensity and extend the regions of high turbulence intensity within the liquid metal bath. Increases in turbulence intensity and distortion of turbulence distribution in the bath promote the occurrence of pouring operation instabilities, thereby resulting in a deterioration of the liquid metal quality.

The invention is designed to address these conventional drawbacks.

### SUMMARY OF THE INVENTION

In an example embodiment of the invention, a refractory impact pad includes a bottom wall, a side wall, and a top wall. The bottom wall has a basal surface. The side wall extends from a periphery of the bottom wall. The side wall has an inner surface that at least partially encircles the basal surface of the bottom wall. The inner surface of the side wall has inner surface teeth distributed thereon and protruding inwardly from the inner surface of the side wall. The top wall is joined to the side wall and separated from the bottom wall by the side wall. The top wall extends over the inner surface of the side wall and the inner surface teeth of the side wall. The top wall has a bottom surface facing the bottom wall. The bottom surface of the top wall has bottom surface teeth distributed thereon and protruding toward the bottom wall. Each of the bottom surface teeth being discretely formed with one of the inner surface teeth.

In another example embodiment of the invention, a metallurgical vessel used for handling liquid metal includes an outer metallic shell, an inner refractory lining, and a refractory impact pad. The outer metallic shell includes a bottom wall and a side wall. The inner refractory lining is positioned on inner surfaces of the bottom wall of the outer metallic shell and the side wall of the outer metallic shell and includes a bottom wall and a side wall. The refractory impact pad is positioned on the bottom wall of the inner refractory lining. The refractory impact pad includes an impact pad bottom wall, an impact pad side wall, and a top wall. The impact pad bottom wall has a basal surface opposite of a surface on which the impact pad bottom wall is positioned on the bottom wall of the inner refractory lining. The impact pad side wall extends from a periphery of the impact pad bottom wall. The impact pad side wall has an inner surface encircling the basal surface of the impact pad bottom wall. The inner surface of the impact pad side wall has inner surface teeth distributed thereon and protruding inwardly from the inner surface of the impact pad side wall. The top wall is joined to the impact pad side wall and separated from the bottom wall by the impact pad side wall. The top wall extends over the inner surface of the impact pad side wall and the inner surface teeth of the impact pad side wall. The top wall has a bottom surface facing the impact pad bottom wall. The bottom surface of the top wall has bottom surface teeth distributed thereon and protruding toward the impact pad bottom wall. Each of the bottom surface teeth is discretely formed with one of the inner surface teeth.

The present invention provides flow control and turbulence dissipation even in view of common factors that amplify turbulence intensity or distort turbulence distribution within a liquid metal bath in a vessel receiving an incoming stream.

The present invention further provides reduction of the harmful influences that occur because of incoming stream trajectory variation and increases of incoming steam momentum.

The present invention further provides reduction of the scale of turbulent eddies that are formed within the refractory impact pad to enhance the dissipation rate of turbulent energy within the refractory impact pad.

The present invention further provides better accommodation of instances in which a large variation of the impact location of the incoming stream on the basal surface of the refractory impact pad occurs.

These and other advantages will become apparent from the following description of a preferred embodiment taken together with the accompanying drawings and claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1a is a partial top view illustrating an example of the refractory impact pad according to an embodiment of the invention;

FIG. 1b is a sectional side view illustrating an example of the refractory impact pad in the direction of “A” according to the embodiment of the invention illustrated in FIG. 1a;

FIG. 1c is a perspective view illustrating an example of the refractory impact pad according to the embodiment of the invention illustrated in FIG. 1a;

FIG. 2a is a partial top view illustrating an example of the refractory impact pad according to another embodiment of the invention;

FIG. 2b is a sectional side view illustrating an example of the refractory impact pad in the direction of “B” according to the embodiment of the invention illustrated in FIG. 2a;

FIG. 2c is a perspective view illustrating an example of the refractory impact pad according to the embodiment of the invention illustrated in FIG. 2a;

FIG. 3a is a top view illustrating an example of the refractory impact pad according to yet another embodiment of the invention;

FIG. 3b is a transparent side view illustrating an example of the refractory impact pad in the direction of “C” according to the embodiment of the invention illustrated in FIG. 3a;

FIG. 3c is a perspective view illustrating an example of the refractory impact pad according to the embodiment of the invention illustrated in FIG. 3a;

FIG. 4a is a top view illustrating an example of the refractory impact pad according to still another embodiment of the invention;

FIG. 4b is a transparent side view illustrating an example of the refractory impact pad in the direction of “D” according to the embodiment of the invention illustrated in FIG. 4a;

FIG. 4c is a perspective view illustrating an example of the refractory impact pad according to the embodiment of the invention illustrated in FIG. 4a;

FIG. 5a is a top view illustrating an example of the refractory impact pad according to an additional embodiment of the invention;

FIG. 5b is a transparent view illustrating an example of the refractory impact pad in the direction of “E” according to the embodiment of the invention illustrated in FIG. 5a;

FIG. 5c is a perspective view illustrating an example of the refractory impact pad according to the embodiment of the invention illustrated in FIG. 5a; and

FIG. 6 is a sectional view of a metallurgical vessel in which the refractory impact pad illustrated in FIGS. 3a, 3b, and 3c has been inserted.

### DETAILED DESCRIPTION OF THE INVENTION

Referring now to the drawings, wherein the showing is for illustrating a preferred embodiment of the invention only and not for limiting same, various embodiments of the invention will be described.

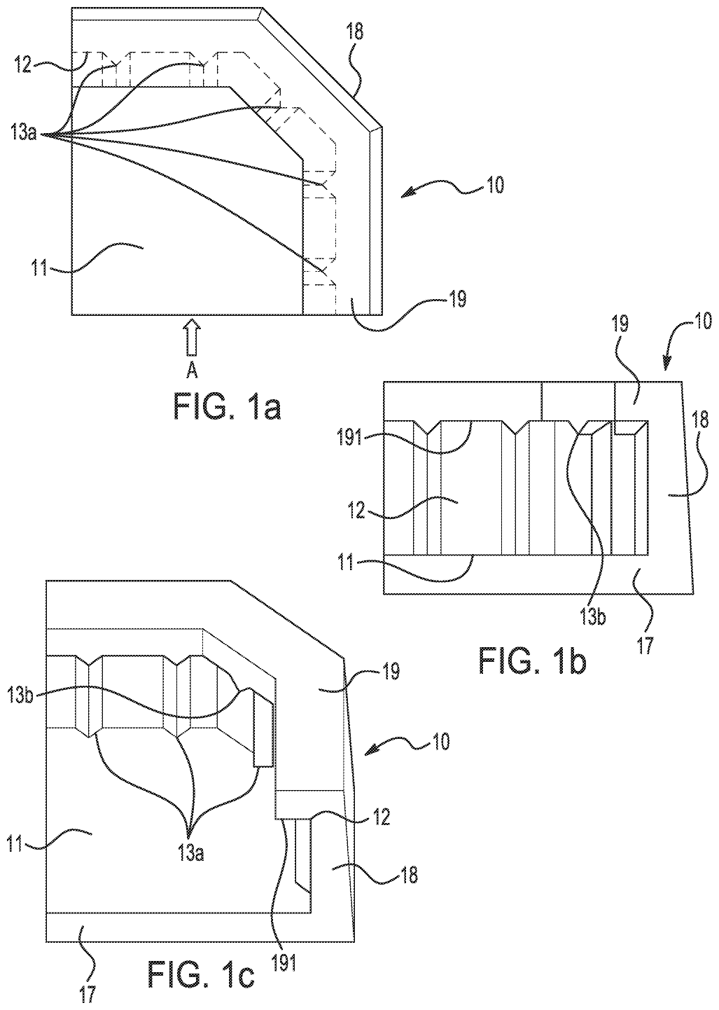

FIGS. 1a-1c illustrate a refractory impact pad 10 in accordance with an embodiment of the invention. The refractory impact pad 10 includes a bottom wall 17, a side wall 18, and a top wall 19. The bottom wall 17 has an upwardly-facing basal surface 11. The side wall 18 is positioned at and extends upwardly from a periphery of the bottom wall 17. The side wall 18 has an inner surface 12 that at least partially encircles the basal surface 11 of the bottom wall 17. The inner surface 12 of the side wall 18 may fully encircle the basal surface 11 of the bottom wall 17. The inner surface 12 includes a plurality of inner surface teeth 13a having discrete tooth-like features distributed on the inner surface 12 of the side wall 18 and protruding inwardly from the inner surface 12 of the side wall 18.

The top wall 19 is joined to the side wall 18 and separated from the bottom wall 17 by the side wall 18. The top wall 19 extends over the inner surface 12 of the side wall 18 and the inner surface teeth 13a of the inner surface 12. The top wall 19 has a bottom surface 191 facing the bottom wall 17. The bottom surface 191 of the top wall 19 has bottom surface teeth 13b having discrete tooth-like features distributed on the bottom surface 191 of the top wall 19. The bottom surface teeth 13b protrude toward the bottom wall 17. Each of the bottom surface teeth 13b is discretely formed with one of the inner surface teeth 13a.

The side wall 18 is joined with the top wall 19 such that, in a vertical cross-section orthogonal to the inner surface 12, the general shape of an inverted L extends over the inner surface 12 of the side wall 18 and the inner surface teeth 13a of the inner surface 12. Further, the top wall 19 of refractory impact pad 10 extends over a periphery of the basal surface 11. In addition, the bottom surface teeth 13b of the refractory impact pad 10 extend over the periphery of the basal surface 11. Moreover, in a vertical cross-section orthogonal to the inner surface 12, the inner surface teeth 13a and the bottom surface teeth 13b form a shape of an inverted L extending over a periphery of the basal surface 11. Each of the inner surface teeth 13a and the bottom surface teeth 13b has an angular configuration of the protruding faces of the teeth that create pointed structures respectively protruding from the inner surface 12 of the side wall 18 and the bottom surface 191 of the top wall 19. The inner surface teeth 13a are in contact with the basal surface 11.

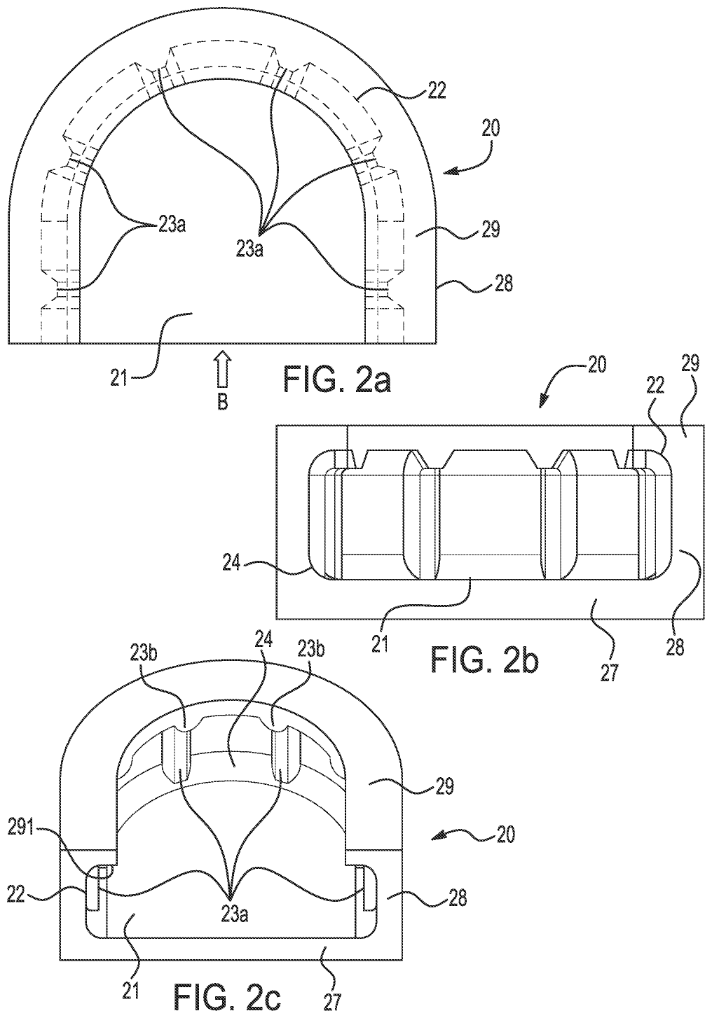

FIGS. 2a-2c illustrate a refractory impact pad 20 in accordance with another embodiment of the invention. The refractory impact pad 20 includes a bottom wall 27, a side wall 28, and a top wall 29. The bottom wall 27 has an upwardly-facing basal surface 21. The side wall 28 is positioned at and extends upwardly from a periphery of the bottom wall 27. The side wall 28 has an inner surface 22 that at least partially encircles the basal surface 21 of the bottom wall 27. The inner surface 22 of the side wall 28 may also fully encircle the basal surface 21 of the bottom wall 27. The inner surface 22 includes a plurality of inner surface teeth 23a having discrete tooth-like features distributed on the inner surface 22 of the side wall 28 and protruding inwardly from the inner surface 22 of the side wall 28.

The top wall 29 is joined to the side wall 28 and separated from the bottom wall 27 by the side wall 28. The top wall 29 extends over the inner surface 22 of the side wall 28 and the inner surface teeth 23a of the inner surface 22. The top wall 29 has a bottom surface 291 facing the bottom wall 27. The bottom surface 291 of the top wall 29 has bottom surface teeth 23b having discrete tooth-like features distributed on the bottom surface 291 of the top wall 29. The bottom surface teeth 23b protrude toward the bottom wall 27. Each of the bottom surface teeth 23b is discretely formed with one of the inner surface teeth 23a.

The side wall 28 is joined with the top wall 29 such that, in a vertical cross-section orthogonal to the inner surface 22, the general shape of an inverted L extends over the inner surface 22 of the side wall 28 and the inner surface teeth 23a of the inner surface 22. Further, the top wall 29 of the refractory impact pad 20 extends over a periphery of the basal surface 21. In addition, the bottom surface teeth 23b of the refractory impact pad 20 extend over the periphery of the basal surface 21. Moreover, in a vertical cross-section orthogonal to the inner surface 22, the inner surface teeth 23a and the bottom surface teeth 23b form a shape of an inverted L extending over a periphery of the basal surface 21.

The refractory impact pad 20 also includes an upwardly-curved wall 24 formed between the side wall 28 and the bottom wall 27. The upwardly-curved wall 24 connects the periphery of the basal surface 21 of the bottom wall 27 to the inner surface 22 of the side wall 28. The inner surface teeth 23a are in contact with the upwardly-curved wall 24. In addition, the inner surface teeth 23a are flat at an innermost edge thereof. Further, the bottom surface teeth 23b are flat at a bottommost edge thereof.

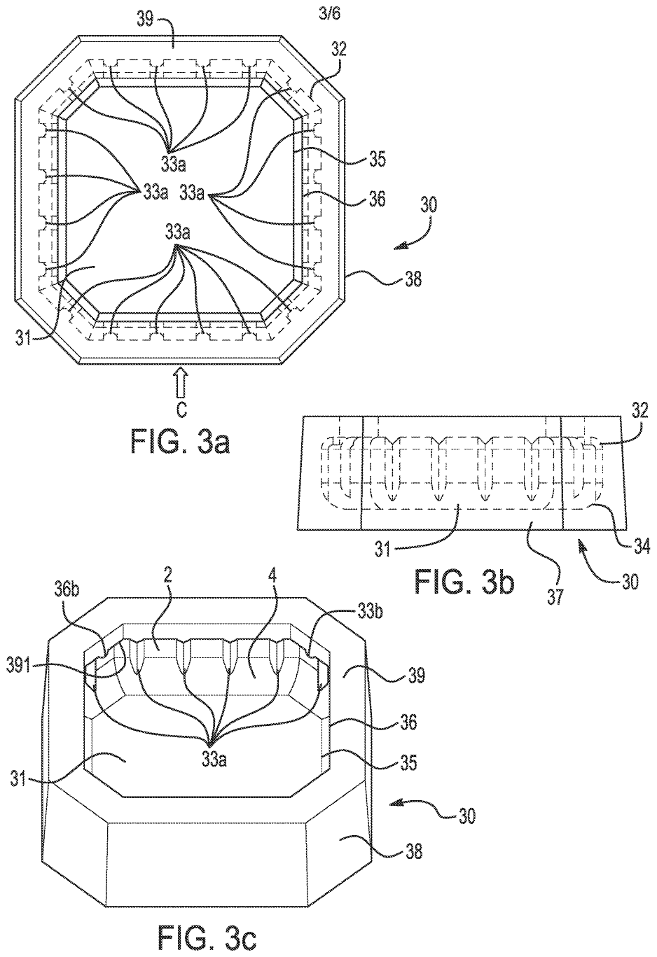

FIGS. 3a-3c illustrate a refractory impact pad 30 in accordance with yet another embodiment of the invention. The refractory impact pad 30 includes a bottom wall 37, a side wall 38, and a top wall 39. The bottom wall 37 has an upwardly-facing basal surface 31. The side wall 38 is positioned at and extends upwardly from a periphery of the bottom wall 37. The side wall 38 has an inner surface 32 that at least partially encircles the basal surface 31 of the bottom wall 37. The inner surface 32 of the side wall 38 may also fully encircle the basal surface 31 of the bottom wall 37. The inner surface 32 includes a plurality of inner surface teeth 33a having discrete tooth-like features distributed on the inner surface 32 of the side wall 38 and protruding inwardly from the inner surface 32 of the side wall 38.

The top wall 39 is joined to the side wall 38 and separated from the bottom wall 37 by the side wall 38. The top wall 39 extends over the inner surface 32 of the side wall 38 and the inner surface teeth 33a of the inner surface 32. The top wall 39 has a bottom surface 391 facing the bottom wall 37. The bottom surface 391 of the top wall 39 has bottom surface teeth 33b having discrete tooth-like features distributed on the bottom surface 391 of the top wall 39. The bottom surface teeth 33b protrude toward the bottom wall 37. Each of the bottom surface teeth 33b is discretely formed with one of the inner surface teeth 33a.

The side wall 38 is joined with the top wall 39 such that, in a vertical cross-section orthogonal to the inner surface 32, the general shape of an inverted L extends over the inner surface 32 of the side wall 38 and the inner surface teeth 33a of the inner surface 32. Each of the inner surface teeth 33a and the bottom surface teeth 33b has an angular configuration of the protruding faces of the teeth that create pointed structures respectively protruding from the inner surface 32 of the side wall 38 and the bottom surface 391 of the top wall 39.

The refractory impact pad 30 also includes an upwardly-curved wall 34 formed between the side wall 38 and the bottom wall 37. The upwardly-curved wall 34 connects the periphery of the basal surface 31 of the bottom wall 37 to the inner surface 32 of the side wall 38. The inner surface teeth 33a are in contact with the upwardly-curved wall 34. In addition, an outermost edge 35 of the periphery of the basal surface 31 is closer to an axis extending orthogonally through a center of the basal surface 31 than an innermost edge 36 of the top wall 39.

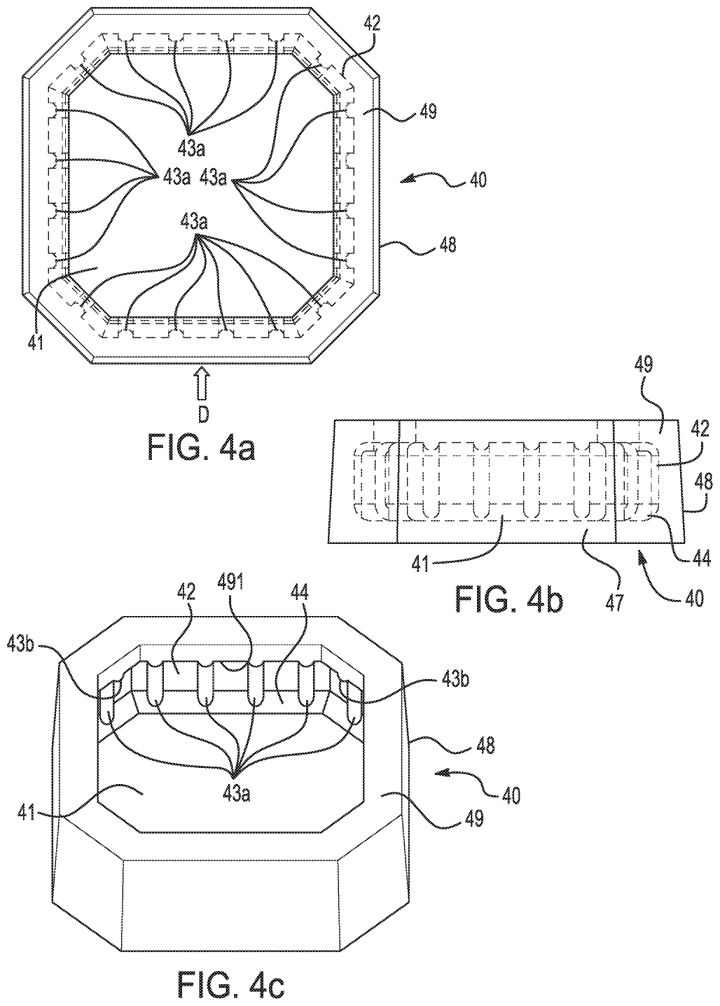

FIGS. 4a-4c illustrate a refractory impact pad 40 in accordance with still another embodiment of the invention. The refractory impact pad 40 includes a bottom wall 47, a side wall 48, and a top wall 49. The bottom wall 47 has an upwardly-facing basal surface 41. The side wall 48 is positioned at and extends upwardly from a periphery of the bottom wall 47. The side wall 48 has an inner surface 42 that at least partially encircles the basal surface 41 of the bottom wall 47. The inner surface 42 of the side wall may also fully encircle the basal surface 41 of the bottom wall 47. The inner surface 42 includes a plurality of inner surface teeth 43a having discrete tooth-like features distributed on the inner surface 42 of the side wall 48 and protruding inwardly from the inner surface 42 of the side wall 48.

The top wall 49 is joined to the side wall 48 and separated from the bottom wall 47 by the side wall 48. The top wall 49 extends over the inner surface 42 of the side wall 48 and the inner surface teeth 43a of the inner surface 42. The top wall 49 has a bottom surface 491 facing the bottom wall 47. The bottom surface 491 of the top wall 49 has bottom surface teeth 43b having discrete tooth-like features distributed on the bottom surface 491 of the top wall 49. The bottom surface teeth 43b protrude toward the bottom wall 47. Each of the bottom surface teeth 43b is discretely formed with one of the inner surface teeth 43a.

The side wall 48 is joined with the top wall 49 such that, in a vertical cross-section orthogonal to the inner surface 42, the general shape of an inverted L extends over the inner surface 42 of the side wall 48 and the inner surface teeth 43a of the inner surface 42. Further, the top wall 49 of the refractory impact pad 40 extends over a periphery of the basal surface 41. In addition, the bottom surface teeth 43b of the refractory impact pad 40 extend over the periphery of the basal surface 41. Moreover, in a vertical cross-section orthogonal to the inner surface 42, the inner surface teeth 43a and the bottom surface teeth 43b form a shape of an inverted L extending over a periphery of the basal surface 41.

The refractory impact pad 40 also includes an upwardly-curved wall 44 formed between the side wall 48 and the bottom wall 47. The upwardly-curved wall 44 connects the periphery of the basal surface 41 of the bottom wall 47 to the inner surface 42 of the side wall 48. The inner surface teeth 43a are in contact with the upwardly-curved wall 44. In addition, the inner surface teeth 53a have a rounded profile protruding inwardly from the inner surface 42 of the side wall 48. Further, the bottom surface teeth 43b have a rounded profile protruding toward the bottom wall 49.

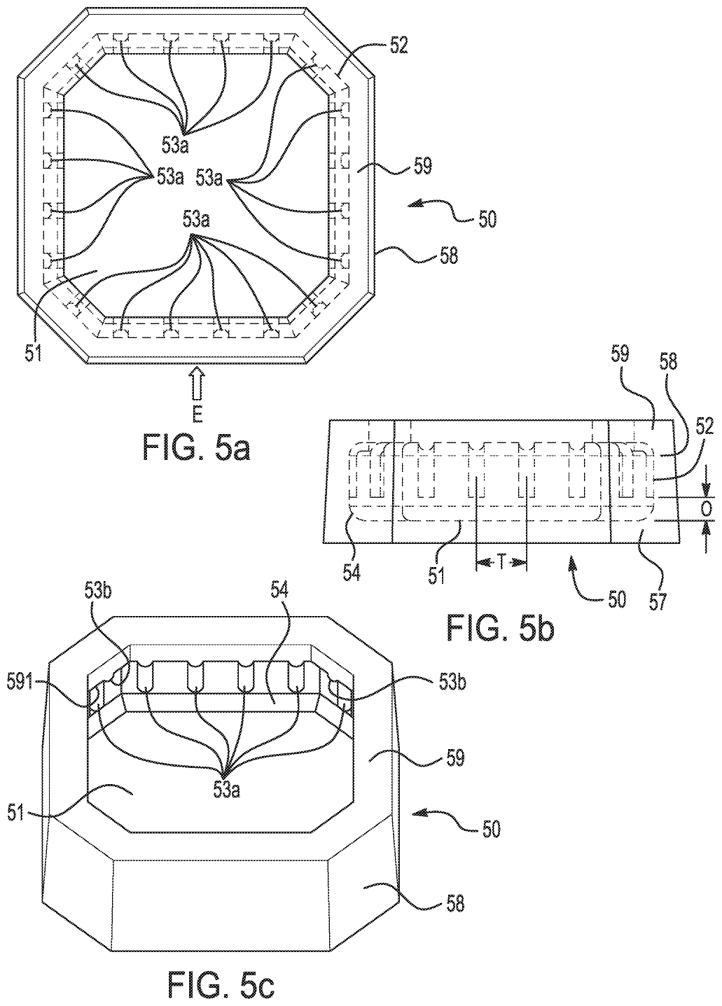

FIGS. 5a-5c illustrate a refractory impact pad 50 in accordance with still another embodiment of the invention. The refractory impact pad 50 includes a bottom wall 57, a side wall 58, and a top wall 59. The bottom wall 57 has an upwardly-facing basal surface 51. The side wall 58 is positioned at and extends upwardly from a periphery of the bottom wall 57. The side wall 58 has an inner surface 52 that at least partially encircles the basal surface 51 of the bottom wall 57. The inner surface 52 of the side wall 58 may also fully encircle the basal surface 51 of the bottom wall 57. The inner surface 52 includes a plurality of inner surface teeth 53a having discrete tooth-like features distributed on the inner surface 52 of the side wall 58 and protruding inwardly from the inner surface 52 of the side wall 58.

The top wall 59 is joined to the side wall 58 and separated from the bottom wall 57 by the side wall 58. The top wall 59 extends over the inner surface 52 of the side wall 58 and the inner surface teeth 53a of the inner surface 52. The top wall 59 has a bottom surface 591 facing the bottom wall 57. The bottom surface 591 of the top wall 59 has bottom surface teeth 53b having discrete tooth-like features distributed on the bottom surface 591 of the top wall 59. The bottom surface teeth 53b protrude toward the bottom wall 57. Each of the bottom surface teeth 53b is discretely formed with one of the inner surface teeth 53a.

The side wall 58 is joined with the top wall 59 such that, in a vertical cross-section orthogonal to the inner surface 52, the general shape of an inverted L extends over the inner surface 52 of the side wall 58 and the inner surface teeth 53a of the inner surface 52. Further, the top wall 59 of the refractory impact pad 50 extends over a periphery of the basal surface 51. In addition, the bottom surface teeth 53b of the refractory impact pad 50 extend over the periphery of the basal surface 51. Moreover, in a vertical cross-section orthogonal to the inner surface 52, the inner surface teeth 53a and the bottom surface teeth 53b form a shape of an inverted L extending over a periphery of the basal surface 51.

The refractory impact pad 50 also includes an upwardly-curved wall 54 formed between the side wall 58 and the bottom wall 57. The upwardly-curved wall 54 connects the periphery of the basal surface 51 of the bottom wall 57 to the inner surface 52 of the side wall 58. In addition, the inner surface teeth 53a have a rounded profile protruding inwardly from the inner surface 52 of the side wall 58. Further, the bottom surface teeth 53b have a rounded profile protruding toward the bottom wall 59.

As is shown particularly in FIG. 5b, the inner surface teeth 53a are separated from the upwardly-curved wall 54. Further, the offset distance O is representative of the difference in elevation between the basal surface 51 and the lowest edges of the inner surface teeth 53a. To achieve an optimum control of the size of turbulent eddies introduced into the flow, the offset distance O should not exceed a separation distance T between the centerlines of adjacent ones of the inner surface teeth 53a.

It is noted that, in all embodiments, including those illustrated in FIG. 1B, in which the inner surface teeth 13a are in contact with the basal surface 11, and those illustrated in FIGS. 2b, 3b, and 4b, in which inner surface teeth 23a, 33a, and 43a are respectively in contact with the upwardly-curved walls 24, 34, and 44, the offset distance of the difference in elevation between the basal surfaces 21, 31, and 41 and the lowest edges of the inner surface teeth 23a, 33a, and 43a should not exceed the separation distance between the centerlines of adjacent ones of the inner surface teeth 23a, 33a, and 43a.

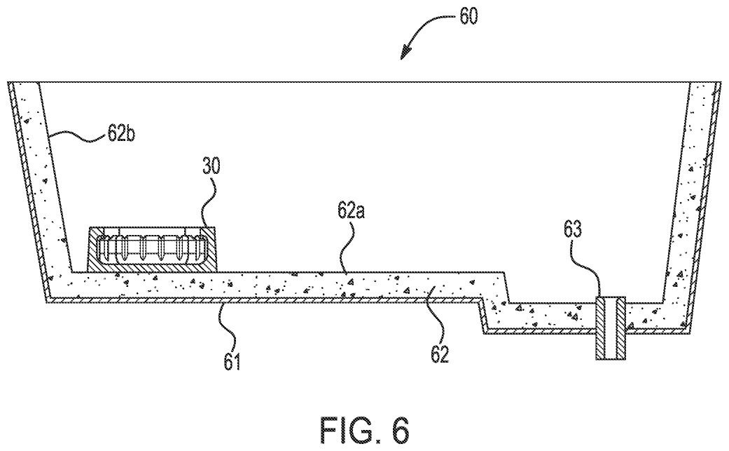

FIG. 6 is a sectional view of an example of a metallurgical vessel 60 used for handling liquid metal in which the refractory impact pad 30 has been inserted. The metallurgical vessel 60 includes an outer metallic shell 61, an inner refractory lining 62, the refractory impact pad 30, and an outlet nozzle 63. The inner refractory lining 62 is positioned on inner surfaces of a bottom wall of the outer metallic shell 61 and a side wall of the outer metallic shell 61. The inner refractory lining has a bottom wall 62a and a side wall 62b. The refractory impact pad 30 is positioned within the metallurgical vessel 60 on the bottom wall 62a of the inner refractory lining 62.

The features of the refractory impact pad 30 illustrated in FIG. 6 are the same as the features of the refractory impact pad 30 illustrated in FIGS. 3a, 3b, and 3c. Moreover, the refractory impact pads 10, 20, 40, and 50 can also be inserted into the metallurgical vessel 60 or a vessel corresponding therewith. For example, the oval-shaped refractory impact pad 20 may be inserted into a metallurgical vessel having a bottom wall and a side wall with a shape that corresponds with the shape of the bottom wall 27 and the side wall 28 of the refractory impact pad 20.

The harmful influences of incoming stream trajectory variation and increases of incoming stream momentum are substantially reduced as a result of the above-referenced inner surface teeth 13a, 23a, 33a, 43a, and 53a and bottom surface teeth 13b, 23b, 33b, 43b, and 53b. These discrete teeth beneficially interact with the liquid metal flow to provide multiple connected regions of enhanced turbulence dissipation within the device. The kinetic energy of turbulence is subsequently reduced from larger scales to smaller scales to allow viscous friction to act more effectively for the dissipation of the turbulence in the liquid metal.

The presence of the teeth on the inner surfaces 12, 22, 32, 42, and 52 of the side walls 18, 28, 38, 48, and 58 and the teeth on the bottom surfaces 191, 291, 391, 491, and 591 of the top walls 19, 29, 39, 49, and 59 of the respective refractory impact pads 10, 20, 30, 40, and 50 effectively and efficiently increase the cumulative length of the walls of the refractory impact pads 10, 20, 30, 40, and 50, thereby increasing turbulence dissipation within the refractory impact pads 10, 20, 30, 40, and 50, while simultaneously maintaining a connected interior space within the refractory impact pads 10, 20, 30, 40, and 50. As such, the small scale eddies generated by the aforesaid unique features interact, thereby dissipating turbulence and provide smoother and more homogeneous flow exiting the refractory impact pads 10, 20, 30, 40, and 50.

Moreover, the size of the basal surfaces 11, 21, 31, 41, and 51 of the refractory impact pads 10, 20, 30, 40, and 50 can be increased to better accommodate instances in which a large variation of the impact location of the incoming stream on the basal surfaces 11, 21, 31, 41, and 51 of the refractory impact pads 10, 20, 30, 40, and 50 occur. In such instances, the number of teeth can be increased, thereby eliminating or alleviating any loss of effectiveness of the refractory impact pads 10, 20, 30, 40, and 50 in achieving flow control and turbulence dissipation.

While examples of the refractory impact pad are provided above in conjunction with the various embodiments, the teeth in the refractory impact pads 10, 20, 30, 40, and 50 allow for adoption into any overall footprint convenient to its application. For example, the basal surface may be circular, as illustrated in FIGS. 2a-2c, oval, square, rectangular, or multisided, as is illustrated in FIGS. 1a-1c, 3a-3c, 4a-4c, and 5a-5c.

The foregoing descriptions regard specific embodiments of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A refractory impact pad, comprising:
a bottom wall having a basal surface;
a side wall extending from a periphery of the bottom wall, the side wall having an inner surface that at least partially encircles the basal surface of the bottom wall, the inner surface of the side wall having inner surface teeth distributed thereon and protruding inwardly from the inner surface of the side wall; and
a top wall joined to the side wall and separated from the bottom wall by the side wall, the top wall extending over the inner surface of the side wall and the inner surface teeth of the inner surface, the top wall having a bottom surface facing the bottom wall, the bottom surface of the top wall having bottom surface teeth distributed thereon and protruding toward the bottom wall, each of the bottom surface teeth being discretely formed with one of the inner surface teeth.

2. The refractory impact pad according to claim 1, wherein the top wall extends over a periphery of the basal surface.

3. The refractory impact pad according to claim 1, wherein the side wall is joined with the top wall such that, in a vertical cross-section orthogonal to the inner surface, the shape of an inverted L is formed extending over the inner surface of the side wall and the inner surface teeth of the inner surface.

4. The refractory impact pad according to claim 1, wherein the bottom surface teeth extend over a periphery of the basal surface.

5. The refractory impact pad according to claim 1, wherein, in a vertical cross-section orthogonal to the inner surface, the inner surface teeth and the bottom surface teeth form a shape of an inverted L extends over a periphery of the basal surface.

6. The refractory impact pad according to claim 1, wherein the inner surface teeth have a pointed innermost edge, and
wherein the bottom surface teeth have a pointed bottommost edge.

7. The refractory impact pad according to claim 1, wherein the inner surface teeth are in contact with the basal surface.

8. The refractory impact pad according to claim 1, further comprising:
an upwardly-curved wall formed between the side wall and the bottom wall, the upwardly-curved wall connecting the periphery of the basal surface of the bottom wall to the inner surface of the side wall,
wherein the inner surface teeth are in contact with the upwardly-curved wall.

9. The refractory impact pad according to claim 1, wherein the inner surface teeth are flat at an innermost edge thereof, and
wherein the bottom surface teeth are flat at a bottommost edge thereof.

10. The refractory impact pad according to claim 1, further comprising:
an upwardly-curved wall formed between the side wall and the bottom wall, the upwardly-curved wall connecting the periphery of the basal surface of the bottom wall to the inner surface of the side wall,
wherein the inner surface teeth are in contact with the upwardly-curved wall, and
wherein an outermost edge of the periphery of the basal surface is closer to an axis extending orthogonally through a center of the basal surface than an innermost edge of the top wall.

11. The refractory impact pad according to claim 1, wherein each of the inner surface teeth has a rounded profile protruding inwardly from the inner surface of the side wall, and
wherein each of the bottom surface teeth has a rounded profile protruding toward the bottom wall.

12. The refractory impact pad according to claim 1, further comprising:
an upwardly-curved wall formed between the side wall and the bottom wall, the upwardly-curved wall connecting the periphery of the basal surface of the bottom wall to the inner surface of the side wall,
wherein the inner surface teeth are separated from the upwardly-curved wall.

13. The refractory impact pad according to claim 1, wherein an offset distance of a difference in elevation between the basal surface and a lowest edge of each of the inner surface teeth does not exceed a separation distance between centerlines of adjacent ones of the inner surface teeth.

14. The refractory impact pad according to claim 1, wherein the side wall of the refractory impact pad fully encircles the basal surface of the bottom wall.

15. A metallurgical vessel used for handling liquid metal, comprising:
an outer metallic shell comprised of a bottom wall and a side wall;
an inner refractory lining positioned on inner surfaces of the bottom wall of the outer metallic shell and the side wall of the outer metallic shell, the inner refractory lining being comprised of a bottom wall and a side wall; and
a refractory impact pad positioned on the bottom wall of the inner refractory lining, the refractory impact pad comprising:
an impact pad bottom wall having a basal surface opposite of a surface on which the impact pad bottom wall is positioned on the bottom wall of the inner refractory lining;
an impact pad side wall extending from a periphery of the impact pad bottom wall, the impact pad side wall having an inner surface that at least partially encircles the basal surface of the impact pad bottom wall, the inner surface of the impact pad side wall having inner surface teeth distributed thereon and protruding inwardly from the inner surface of the impact pad side wall; and
a top wall joined to the impact pad side wall and separated from the impact pad bottom wall by the impact pad side wall, the top wall extending over the inner surface of the impact pad side wall and the inner surface teeth of the inner surface, the top wall having a bottom surface facing the impact pad bottom wall, the bottom surface of the top wall having bottom surface teeth distributed thereon and protruding toward the impact pad bottom wall, each of the bottom surface teeth being discretely formed with one of the inner surface teeth.

16. The metallurgical vessel according to claim 15, wherein the inner surface of the impact pad side wall fully encircles the basal surface of the impact pad bottom wall.
